(19) United States
(12) Patent Application Publication
(10) Pub. No.: US 2025/0303537 A1
(43) Pub. Date: Oct. 2, 2025

(54) DIGITAL-DISPLAY TORQUE WRENCH WITH MECHANICALLY ADJUSTABLE TORQUE

(71) Applicant: Bobby Hu, Taichung City (TW)

(72) Inventor: Bobby Hu, Taichung City (TW)

(21) Appl. No.: 18/861,015

(22) PCT Filed: Jul. 29, 2022
(86) PCT No.: PCT/CN2022/108939

§ 371 Date: Oct. 28, 2024

(51) Int. Cl. B25B 23/142

(52) U.S. Cl. CPC B25B 23/1427; B25B 23/1425

(57) ABSTRACT

A digital-display torque wrench with mechanically adjustable torque includes a main body, a wrenching device, a torque-breaking device, a specially-shaped elastic member, a torque-adjusting device, a locking device, and a torque-sensing device. The torque-adjusting device has a sliding member, which changes a set torque value of the digital-display torque wrench when sliding along a direction parallel to an axis of the main body. The locking device assembled between the sliding member and the main body can be switched between a releasing position and a locking position. At the releasing position, a bearing portion of the sliding member can move with respect to the specially-shaped elastic member, and the torque-sensing device senses a locational change of the sliding member and displays the set torque value. At the locking position, the locking device exerts a force on the sliding member to increase frictional resistance between the sliding member and the main body.

### TECHNICAL FIELD

The present invention relates to torque wrenches, and more particularly to a digital-display torque wrench with mechanically adjustable torque.

### DESCRIPTION OF RELATED ART

U.S. Patent Application Publication No. 2020/0398410A1 titled “Torque Wrench” discloses a torque wrench that digitally displays its set torque value. The known wrench comprises a main body, a driving portion, a torque-disengageable mechanism, a torque assembly, and an adjusting assembly. The torque assembly has a biasing member and an abutting member. The adjusting assembly comprises a position-limiting member, a slidable assembly, and an adjusting member. The position-limiting member is abutted against the biasing member. The slidable assembly is fixed with the position-limiting member and slidably disposed in the main body. The adjusting member adjusts the slidable assembly to abut the position-limiting member against the biasing member at the corresponding position. When a force exerted on the driving portion is greater than the set torque value of the torque wrench, the torque-disengageable mechanism and the abutting member are disengaged from each other, thereby informing the user that the torque value set for the fastening member is reached.

### SUMMARY OF THE INVENTION

### Technical Problem

However, during wrenching operation of the torque wrench, before the torque born by the driving portion reaches the set value, the counterforce transmitted to the biasing member through the driving portion makes it flexible, and the counterforce also acts on the slidable assembly through the biasing member and the position-limiting member. This makes the slidable assembly jiggle and leads to looseness of the structure eventually. Consequently, torque performance of the torque wrench during its use is less accurate and tends to distort.

German Utility Model No. 202013101035U1 titled “Torque Tool with Trigger Mechanism” is another known torque wrench, which comprises a lever housing, a lever arrangement, a trigger mechanism, and a torque-adjusting device. The lever arrangement is arranged in the lever housing and has two levers each forming a switching edge via which the torque tool triggers. When the torque born by the head is greater than the torque value set for the torque tool, the two levers disengage, thereby informing the user that the torque value set for the fastening member is reached.

Similar to the known wrench described previously, during wrenching operation of the torque tool, before the torque born by the head reaches the set value, the counterforce transmitted to the bendable bar through the head makes it flexible, and the counterforce also acts on the supporting member slidably installed on the guiding member through the bendable bar. This makes the supporting member jiggle with respect to the guiding member and leads to looseness of the structure eventually. Consequently, the torque performance of the torque tool during its use is less accurate and tends to distort.

To meet the needs of consumers, the present invention provides a digital-display torque wrench that features mechanically adjustable torque, high precision, and accurate digital display of torque.

### SOLUTION TO PROBLEMS

### Technical Solution

In order to address the foregoing issues, the objective of the present invention is to provide a digital-display torque wrench with mechanically adjustable torque, which locks its main body and its sliding member using a locking device in a way that the locked structure is compact, thereby ensuring accurate torque during operation of the wrench.

For achieving the foregoing objective, in one embodiment of the present invention, a digital-display torque wrench with mechanically adjustable torque comprises a main body, a wrenching device, a torque-breaking device, a specially-shaped elastic member, a torque-adjusting device, a locking device, and a torque-sensing device; the main body, defining an axis along which a first end and a second end remote from the first end are formed; the wrenching device being swingably attached to the first end of the main body, and comprising a wrenching end exposed outside the main body; the torque-breaking device being pivotally connected in the main body and configured to selectively abut against one end of the wrenching device that is remote from the wrenching end; the specially-shaped elastic member comprising a fixing end and a specially-shaped supporting segment different from the fixing end, wherein the fixing end of the specially-shaped elastic member is fixed to the torque-breaking device; the torque-adjusting device being assembled to the main body, and having a sliding member, wherein the sliding member is installed in the main body to be slidable along a direction parallel to the axis and has a bearing portion, in which the bearing portion configured to abut against the specially-shaped supporting segment of the specially-shaped elastic member; the locking device being assembled between the sliding member and the main body, and configured to be operated between a releasing position and a locking position, wherein when the locking device is in the releasing position, an axial location of the bearing portion of the sliding member with respect to the specially-shaped elastic member is adjustable, and when the locking device is in the locking position, the locking device results in frictional resistance between the sliding member and the main body, thereby preventing the sliding member from moving with respect to the main body; and the torque-sensing device being installed on the main body and aligned with the torque-adjusting device so as to sense a locational change of the sliding member and display a set torque value.

Furthermore, the wrenching end defines a rotational axis about which the main body, when operated for wrenching, rotates, in which when the locking device is in the releasing position, the locking device can be rotated about an operational axis that is parallel to the rotational axis and perpendicular to the axis, so as to make the locational change of the sliding member along the axis; the locking device being in connection with the torque-adjusting device along the operational axis; when being in the locking position, the locking device presses the sliding member along the operational axis, so as to result in the frictional resistance and hold the sliding member and the main body together tightly.

Furthermore, the torque-adjusting device comprises a first force-transferring member configured to drive the sliding member to have the locational change, and the locking device comprises an axial shaft passing through the main body and the sliding member along the operational axis, an operating lever swingably attached to one end of the axial shaft, and a second force-transferring member provided on the axial shaft, in which the operating lever drives the axial shaft to move along the operational axis, and the first force-transferring member and the second force-transferring member are installed on the axial shaft, so that when the locking device is in the locking position, the operating lever pulls the axial shaft along the operational axis to make the first force-transferring member and the second force-transferring member press against each other, thereby holding the main body and the sliding member together tightly, and when the locking device is in the releasing position, the operating lever is released with respect to the axial shaft, so as to be rotated to operate the first force-transferring member and in turn drive the sliding member to slide linearly with respect to the main body.

Furthermore, the wrenching device has an adjusting device, which is used to adjust an abutting level between the wrenching device and the torque-breaking device.

Furthermore, the main body has a top side and a bottom side opposite to each other along the operational axis, in which the axial shaft is exposed outside the main body at the top side for the operating lever to be pivotally connected thereto; the first force-transferring member having a first connecting end and a first pressing portion, the second force-transferring member having a second connecting end and a second pressing portion that is located in the sliding member, the second connecting end being connected to and moving with the first connecting end; and when the locking device is in the locking position, the first pressing portion presses on the main body and the second pressing portion presses on the sliding member.

Furthermore, the first force-transferring member has a force-bearing portion that is remote from the first pressing portion, and the operating lever has an eccentric cam, while the locking device comprises a force-transferring assembly that abuts between the eccentric cam and the force-bearing portion, whereby when the locking device is in the locking position, the eccentric cam applies a force on the force-transferring assembly, and the force-transferring assembly transfers the force to the first force-transferring member; the sliding member having a first toothed portion extending in a direction parallel to the axis, the second force-transferring member having a second toothed portion that is located between the second connecting end and the second pressing portion and about the operational axis, the second toothed portion and the first toothed portion engaging with each other, the first force-transferring member being rotatably installed on the main body and the axial shaft to be rotatable about the operational axis and interlocked with the second force-transferring member in terms of movement, so that when rotated, the first force-transferring member drives the second force-transferring member and in turn drives the sliding member to perform displacement with respect to the main body, the first force-transferring member having a rotating end that is remote from the first connecting end, the rotating end having a first radius of rotation, the second force-transferring member having a second radius of rotation, the second toothed portion being arranged along the second radius of rotation, the first radius of rotation being greater than the second radius of rotation; the first connecting end and the second connecting end engaging with each other by means of complementary fitting.

Furthermore, the wrench further comprises a biasing device, which is arranged between the main body and the sliding member, and applies a spring force to the sliding member along a direction perpendicular to the axis and the operational axis, wherein the biasing device comprises a leaf spring, whose two ends each have a hooking portion to hook a corresponding lateral of the sliding member.

Furthermore, the wrenching device comprises a wrenching member and an abutting member, the wrenching member being pivotally connected to the first end, the wrenching member having a terminal inserted into the main body, the abutting member being pivotally connected to the terminal, the torque-breaking device selectively abutting against the abutting member, the specially-shaped supporting segment having a curved contacting area for the bearing portion to abut thereagainst, the specially-shaped elastic member being installed in the main body and inclined with respect to the axis of the main body; when the bearing portion of the torque-adjusting device abuts against the curved contacting area of the specially-shaped elastic member at a site that is farthest from the fixing end, the set torque value being at the minimum, and when the bearing portion of the torque-adjusting device abuts against the curved contacting area of the specially-shaped elastic member at a site that is closest to the fixing end, the set torque value being at the maximum; when a wrenching force applied by the digital-display torque wrench increases and becomes equal to the set torque value, the torque-breaking device disengaging from the abutting member to break application of the wrenching force; when the digital-display torque wrench returns to an idle state thereof, the torque-breaking device and the abutting member automatically restore to abut against each other; the axis dividing the main body into a forward side and a rearward side, a centerline of the specially-shaped elastic member being inclined with respect to the axis by an angle of inclination, the fixing end of the specially-shaped elastic member being at the rearward side of the main body, the specially-shaped supporting segment of the specially-shaped elastic member crossing the axis of the main body and being located at the forward side of the main body; the torque-breaking device comprising a breaking member, the abutting member abutting against the breaking member; when the wrenching force applied by the digital-display torque wrench increases and becomes equal to the set torque value, the breaking member disengaging from the abutting member to break application of the wrenching force; when the digital-display torque wrench returns to the idle state, the breaking member and the abutting member automatically restoring to abut against each other; the terminal having a lateral formed with a first restricting portion, and the abutting member having a second restricting portion locationally corresponding to the first restricting portion, so that the first restricting portion and the second restricting portion abut against each other to define a swinging range of the abutting member; a restoring member being arranged between the terminal and the abutting member, the restoring member normally making the abutting member and the torque-breaking device abut against each other, an elastic member being arranged between the wrenching member and the main body to provide a force that returns the wrenching member to the idle state; the adjusting device being arranged between the terminal and the abutting member, the adjusting device comprising an adjusting member and a nut that is screwed into one end of the adjusting member, the adjusting member having an opposite end that is screwed into the terminal and abuts against the abutting member, the abutting member having a first abutting portion, the breaking member having a second abutting portion that is located at a lateral different from the specially-shaped elastic member and configured to abut against the first abutting portion, the adjusting member serving to adjust the swinging range of the abutting member with respect to the terminal, thereby changing a contacting area between the first abutting portion and the second abutting portion that abut against each other.

Furthermore, the main body has a top side and a bottom side opposite to the top side along the operational axis, and the axial shaft is exposed outside the main body at the bottom side for the operating lever to be pivotally connected thereto, the first force-transferring member having a first connecting end and a first pressing portion, the second force-transferring member having a second connecting end and a second pressing portion located in the sliding member, and the second connecting end being slidably connected to the first connecting end, so that when the locking device is in the locking position, the first pressing portion presses on the main body, and the second pressing portion presses on the sliding member.

Furthermore, the sliding member has a first toothed portion extending in a direction parallel to the axis, and the first force-transferring member has a second toothed portion that is located remote from the first pressing portion and formed around the operational axis, so that the second toothed portion engages with the first toothed portion, the first force-transferring member being rotatably installed along the operational axis on the axial shaft to be rotated to drive the sliding member to have the locational change with respect to the main body, the first force-transferring member having a rotating end that is remote from the first connecting end, the rotating end having a first radius of rotation, and the second toothed portion being formed along a second radius of rotation, wherein the first radius of rotation is greater than the second radius of rotation; the operating lever having an eccentric cam, when the locking device is in the locking position, the eccentric cam applying a force on the second force-transferring member to make the second force-transferring member and the first force-transferring member press toward each other, thereby holding the main body and the sliding member together tightly; the axial shaft of the locking device being provided with a threaded portion that passes through the first force-transferring member for a first screwing member and a second screwing member to be screwed therearound, and a disc spring being provided between the first screwing member and the first force-transferring member.

Furthermore, the wrench further comprises a biasing device, which is arranged between the main body and the sliding member, and applies a spring force to the sliding member along a direction perpendicular to the axis and the operational axis, wherein the biasing device comprises a leaf spring, whose two ends each have a hooking portion to hook a corresponding lateral of the sliding member.

Furthermore, the axis divides the main body into a forward side and a rearward side, and the main body has an inner wall that includes a first inner wall at the rearward side and a second inner wall at the forward side, the wrenching device comprising a wrenching member, a link, and an acting member, the wrenching member being pivotally connected to the first end, the wrenching member having a terminal, the link being pivotally connected to the terminal, and the acting member being pivotally connected to the main body and configured to act between a first swinging position and a second swinging position with respect to the main body, so that the acting member and the link are interlocked; when the acting member is in the first swinging position, the acting member transmitting a counterforce of the wrenching device to the specially-shaped elastic member; when the torque-breaking device breaks transmission of the force applied by the digital-display torque wrench and makes the acting member swing to the second swinging position, the acting member driving the link to perform displacement with respect to the main body while making the wrenching member hit against the first inner wall, and the acting member hitting against the second inner wall; the wrenching member having a first impacting surface at one lateral of the terminal, a first impact space being defined between the first impacting surface and the first inner wall, the acting member having a second impacting surface at one lateral thereof, a second impact space being defined between the second impacting surface and the second inner wall; when the torque-breaking device breaks transmission of the force applied by the digital-display torque wrench, the first impacting surface entering the first impact space and hitting against the first inner wall, and the second impacting surface entering the second impact space and hitting against the second inner wall; when the digital-display torque wrench is in an idle state, a centerline of the link and the axis jointly including a first included angle, the second impacting surface and the axis jointly including an impact angle, and the link having a first connecting end and a second connecting end opposite to each other, the first connecting end being pivotally connected to the terminal, the second connecting end and the acting member being interlocked, the second connecting end of the link being located at the rearward side; when the torque-breaking device breaks transmission of the force applied by the digital-display torque wrench, the centerline of the link and the axis jointly including a second included angle, the first included angle being greater than the second included angle, the first included angle being greater than the impact angle, and the first connecting end of the link crossing the axis of the main body to be located at the rearward side of the main body together with the second connecting end; the torque-breaking device comprising a breaking member, the wrenching device having an abutting member that is pivotally connected thereto and is opposite to the wrenching end, the abutting member at one lateral contacting and being interlocked with the acting member, and at an opposite lateral abutting against and being connected to the breaking member; when a wrenching force applied by the digital-display torque wrench increases and becomes equal to the set torque value, the breaking member disengaging from the abutting member and thereby breaking transmission of the wrenching force applied by the digital-display torque wrench; when the digital-display torque wrench returns to the idle state, the breaking member and the abutting member automatically restoring to abut against each other; the adjusting device being arranged between the acting member and the abutting member, the adjusting device comprising an adjusting member and a nut screwed to one end of the adjusting member, the adjusting member having an opposite end that is screwedly connected to the abutting member and abuts against the acting member, the abutting member having a first abutting portion, the breaking member having a second abutting portion at a lateral thereof that is opposite to the specially-shaped elastic member to abut against the first abutting portion, the adjusting member being configured to adjust a swinging range of the abutting member with respect to the acting member and to thereby change a contacting area in which the first abutting portion abuts against the second abutting portion; the centerline of the specially-shaped elastic member being inclined with respect to the axis by an angle of inclination, the fixing end of the specially-shaped elastic member being located at the rearward side of the main body, the supporting segment of the specially-shaped elastic member crossing the axis of the main body to be located at the forward side of the main body, the torque-adjusting device when operated adjusting the axial location of the bearing portion with respect to the specially-shaped supporting segment, thereby changing the angle of inclination of the specially-shaped elastic member with respect to the main body; the specially-shaped elastic member being installed in the main body and inclined with respect to the axis of the main body, the specially-shaped supporting segment of the specially-shaped elastic member having a curved contacting area; the wrenching device further comprising two holding plates, the second connecting end of the link being pivotally connected to a lateral of each of the two holding plates, the abutting member being pivotally connected to an opposite lateral of each of the two holding plates, and the acting member being provided in duplicate to be stacked with and fixed to the two holding plates, the acting member having a first restricting portion that is remote from the wrenching end, the abutting member having a second restricting portion locationally corresponding to the first restricting portion, so that the first restricting portion and the second restricting portion abut against each other to define a swinging range of the abutting member; a restoring member being arranged between the acting member and the abutting member to normally make the abutting member and the breaking member abut against each other, and an elastic member being arranged between the wrenching member and the first inner wall of the main body to provide a force that returns the wrenching member to the idle state.

Furthermore, the torque-sensing device comprising a sensing member and a display unit, the display unit being electrically connected to the sensing member, the sensing member having a movable portion, the movable portion being connected to and moving with the sliding member, so that the sensing member senses the locational change of the sliding member and generates a torque signal, the display unit displaying the set torque value according to the torque signal, the main body having an accommodating space, the main body having a sensing window that is between the first end and the second end and is communicated with the accommodating space, the sensing member sensing the locational change of the sliding member through the sensing window, the torque-sensing device further comprising a counter, the counter being configured to send a counting signal according to a number of times of disengagement between the breaking member and the abutting member and display the counting signal at the display unit, the wrenching device having a driving head and a wrenching member, the wrenching member being pivotally connected to the first end, the wrenching end being located at the driving head, the driving head being detachably installed on the wrenching member; and the main body further comprising a handle at the second end.

Thereby, when the locking device is in the locking position to lock the sliding member with respect to the main body, the frictional resistance between the two components increases to make the structure more compact, and this prevents jigging during operation of the wrench, thereby ensuring more precise, non-distortion torque performance of the wrench.

In addition, the present invention also provides quick tripping like a known mechanical torque wrench, and supports rapid adjustment of torque setting, while being made with digital display like a known electronic torque wrench.

### BENEFICIAL EFFECTS OF THE INVENTION

### BRIEF DESCRIPTION OF THE DRAWINGS

### Drawing Description

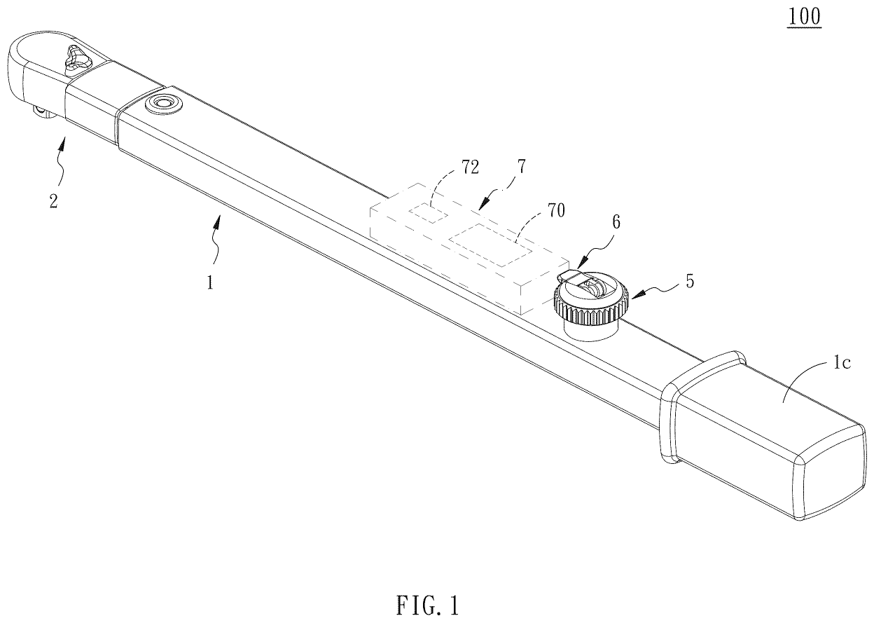

FIG. 1 is a perspective view of a digital-display torque wrench according to a first embodiment of the present invention;

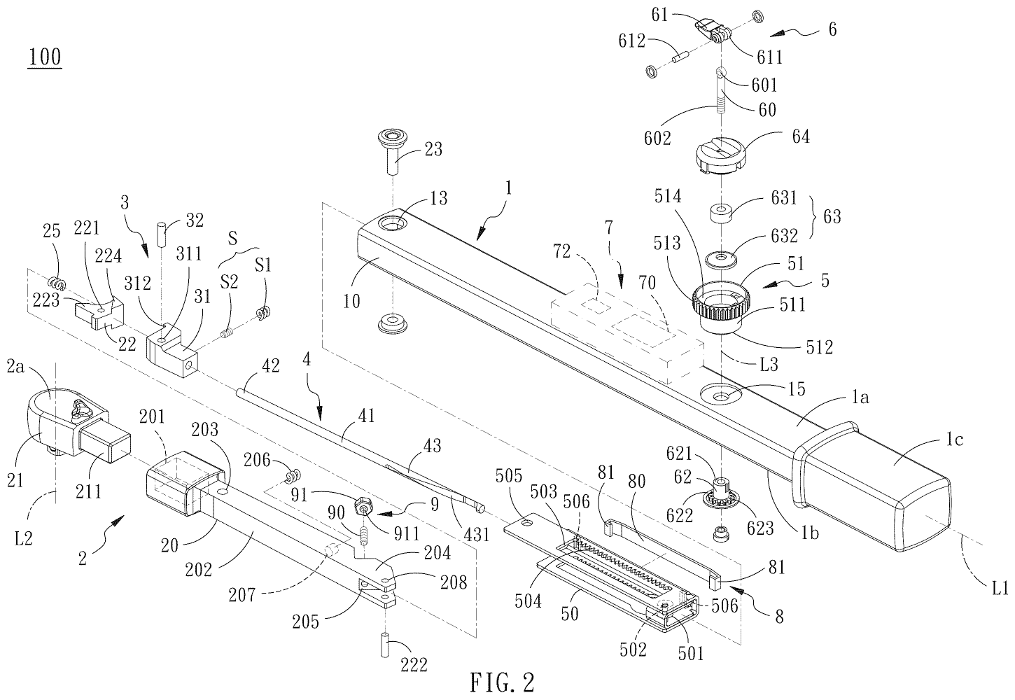

FIG. 2 is an exploded view of the digital-display torque wrench according to the first embodiment of the present invention;

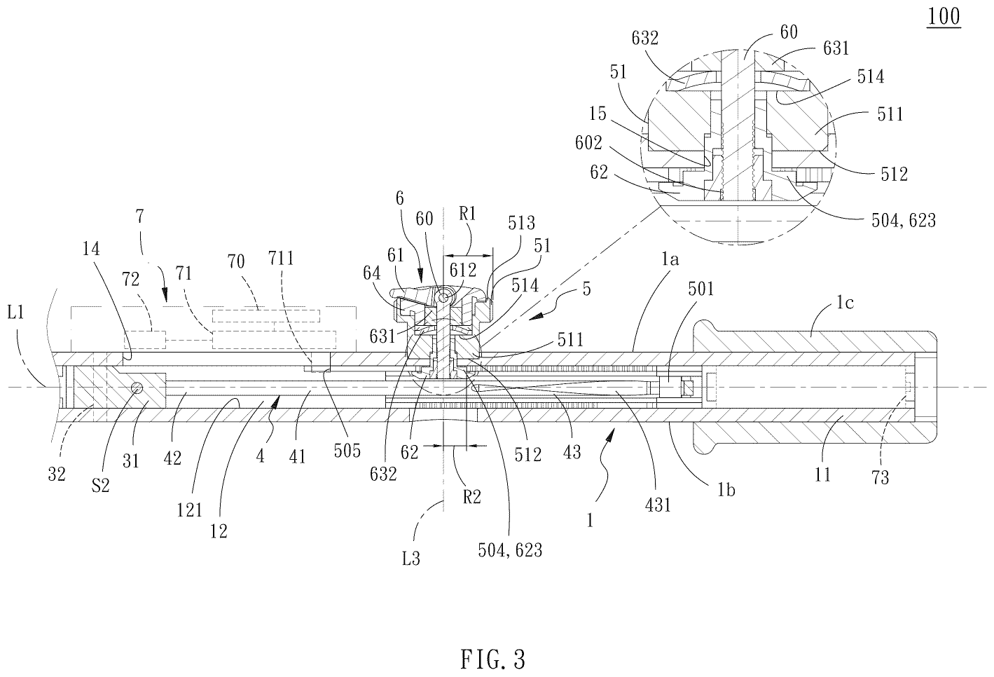

FIG. 3 is a longitudinal section of a part of the torque wrench base on FIG. 1, showing that the locking device is in its locking position;

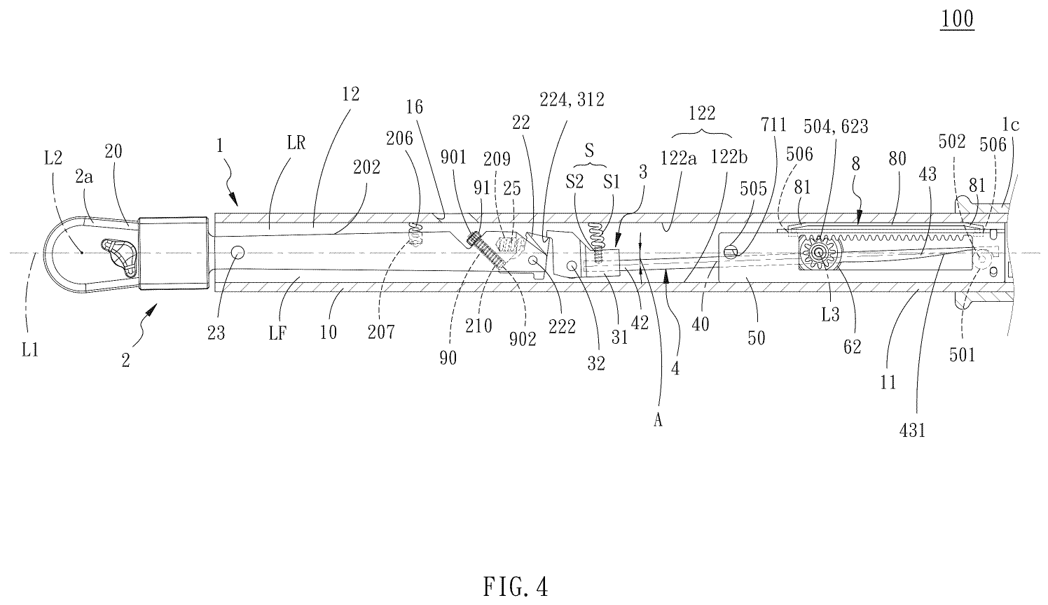

FIG. 4 is a cross section of a part of the torque wrench base on FIG. 1, showing that the bearing portion is at its lower limit and the set torque value is at the minimum;

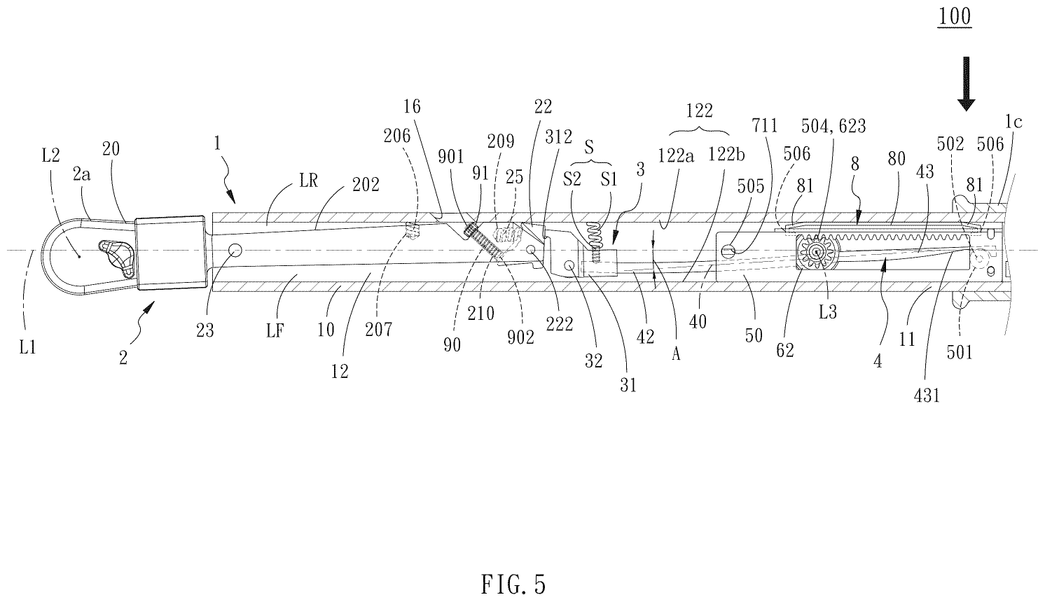

FIG. 5 illustrates wrenching operation of the digital-display torque wrench according to the first embodiment of the present invention, wherein the wrench has tripped;

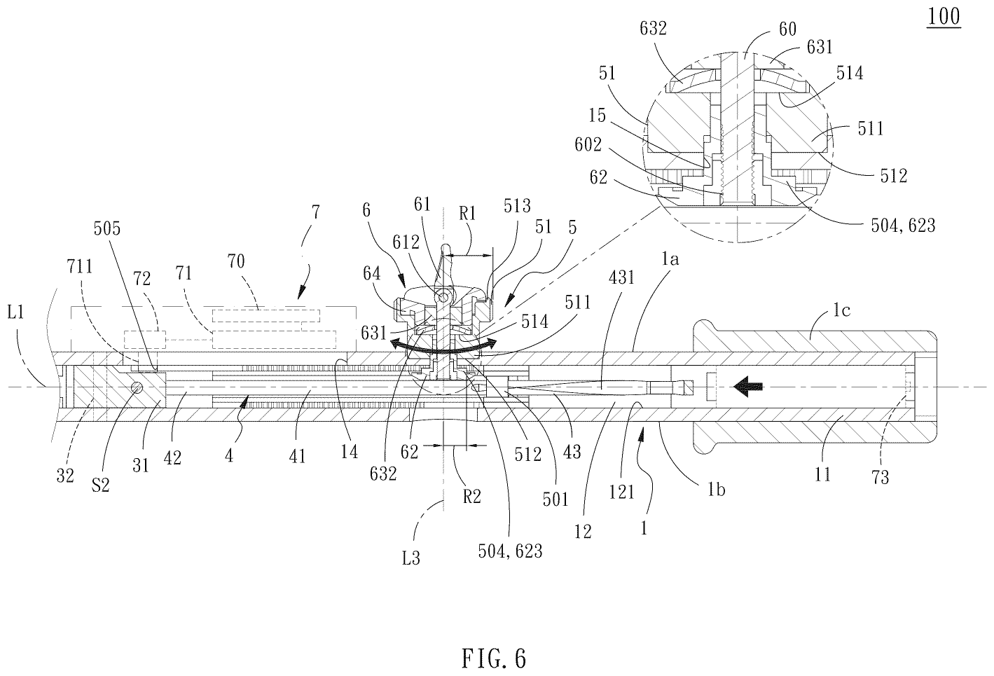

FIG. 6 is a longitudinal section of a part of the digital-display torque wrench of the present invention, showing that the locking device is in its releasing position, and the first force-transferring member now can drive the sliding member to perform linear displacement, thereby bringing the bearing portion to the upper limit;

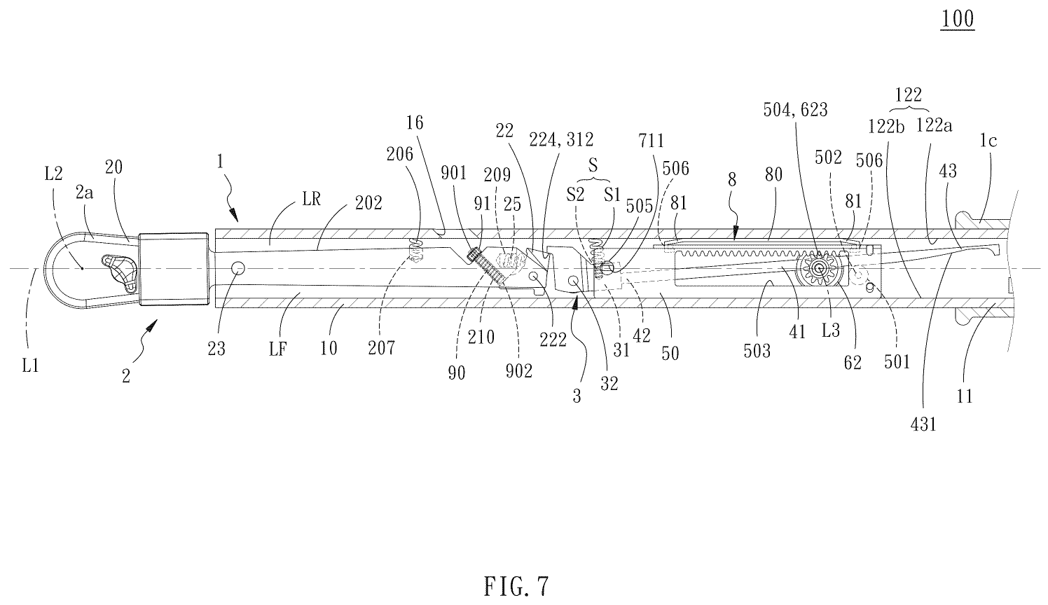

FIG. 7 is a cross section of a part of the digital-display torque wrench of the present invention, showing that the bearing portion is at the upper limit and the set torque value is at the maximum;

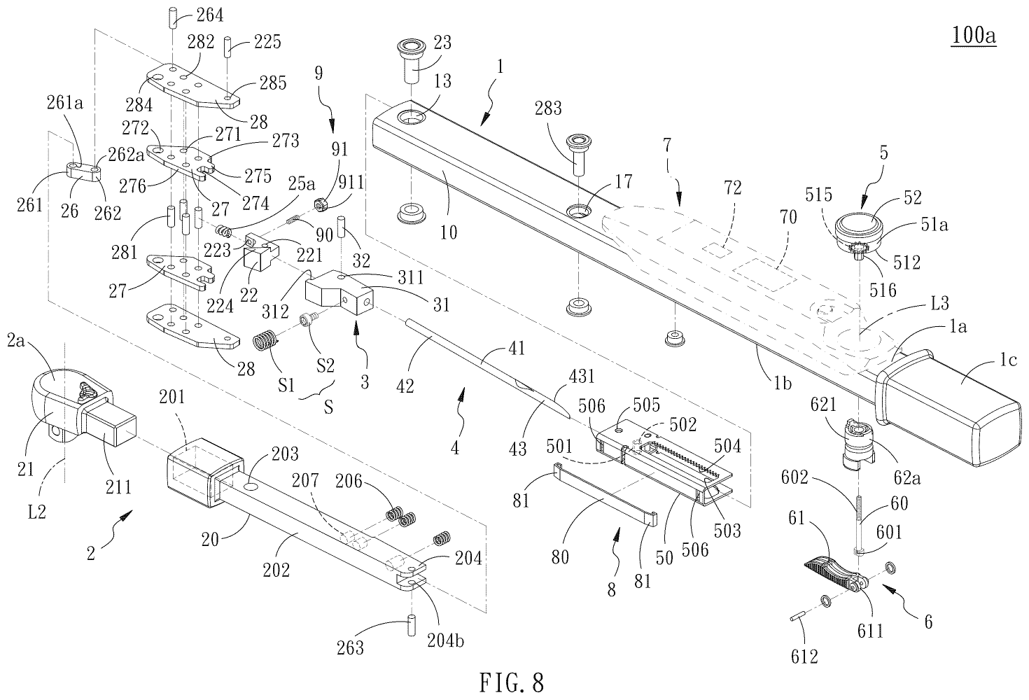

FIG. 8 is an exploded view of a digital-display torque wrench according to a second embodiment of the present invention;

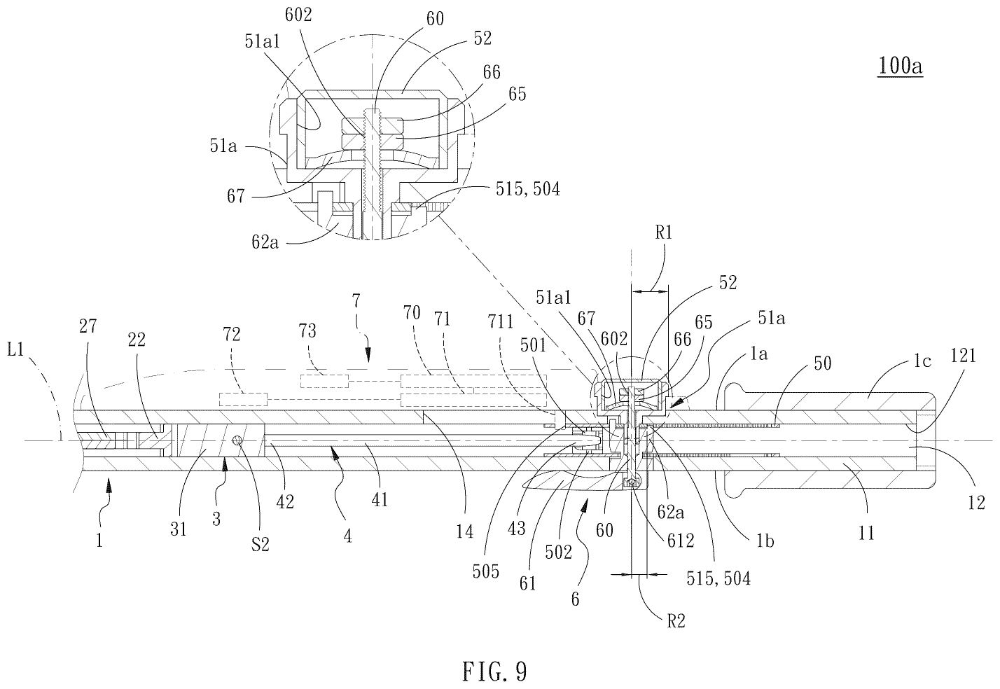

FIG. 9 is a longitudinal section of a part of the torque wrench base on FIG. 8, showing that the locking device is in its locking position;

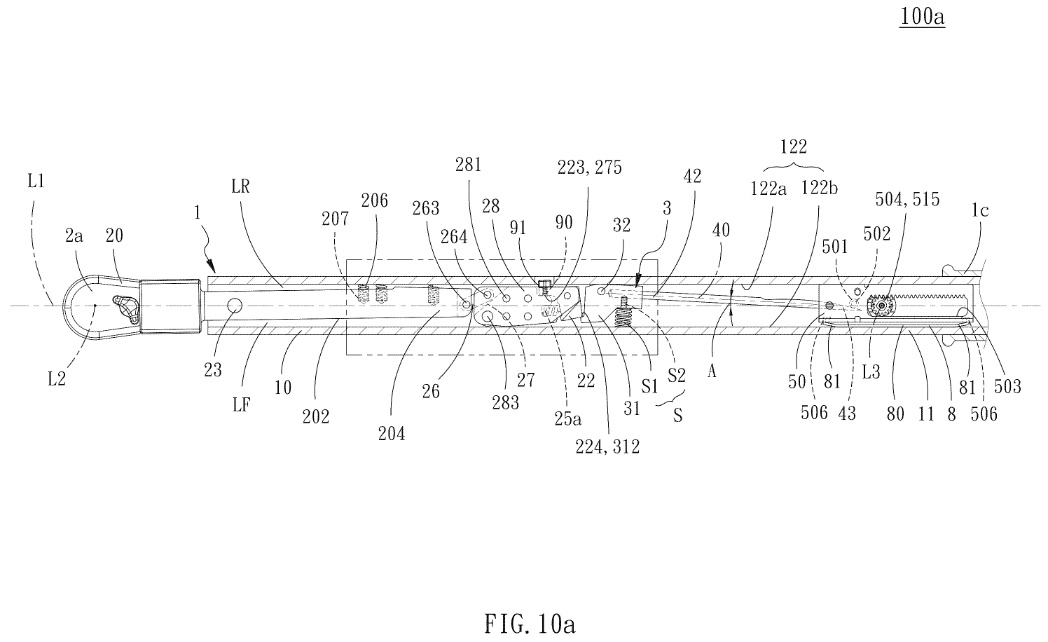

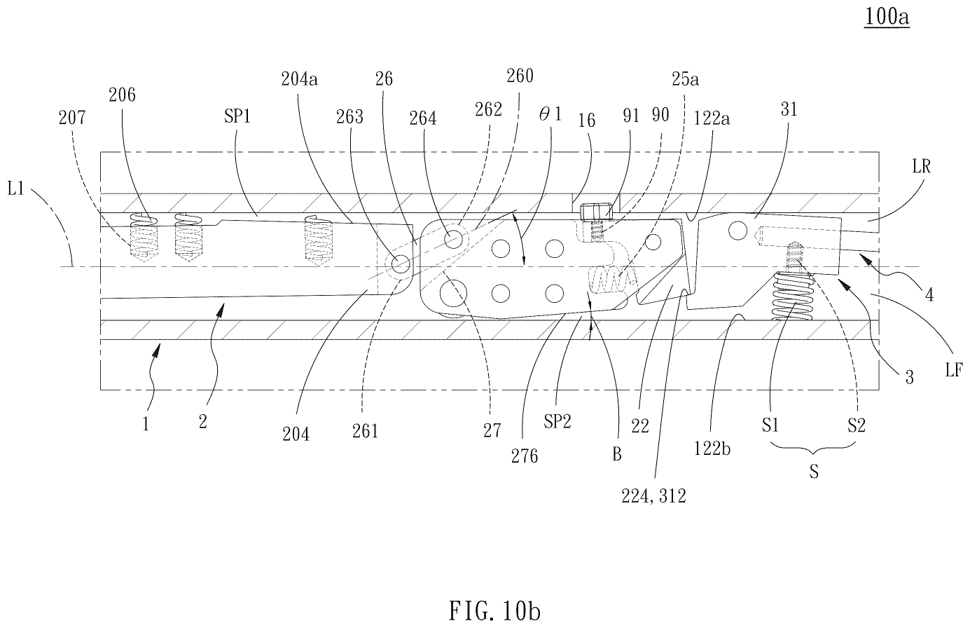

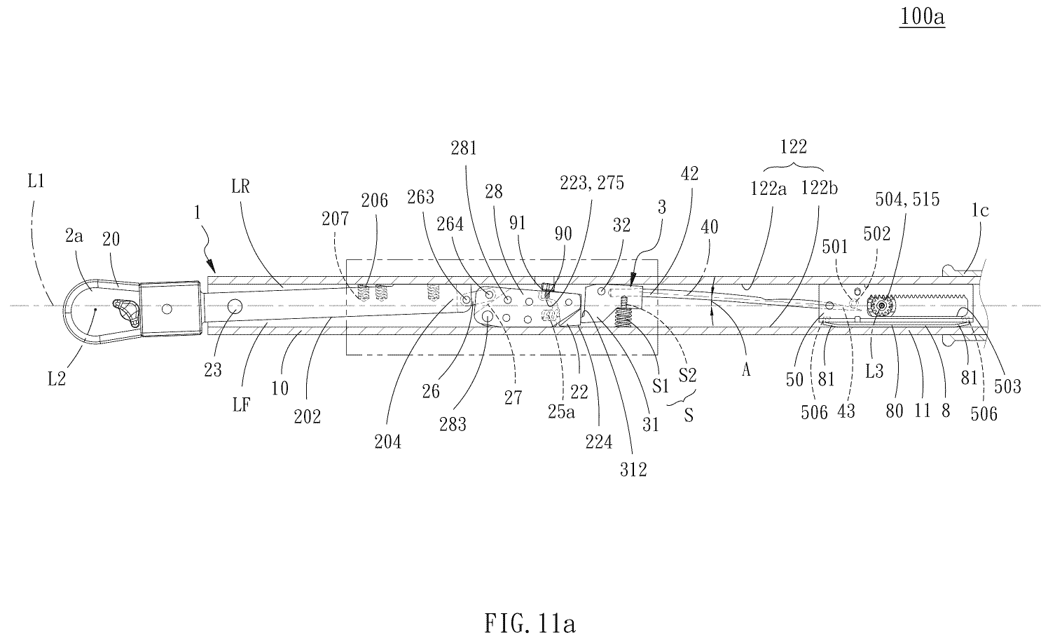

FIG. 10a is a cross section of a part of the torque wrench base on FIG. 8, showing that the bearing portion is at its lower limit and the set torque value is at the minimum;

FIG. 10b is a zoom-in view of a part of FIG. 10a;

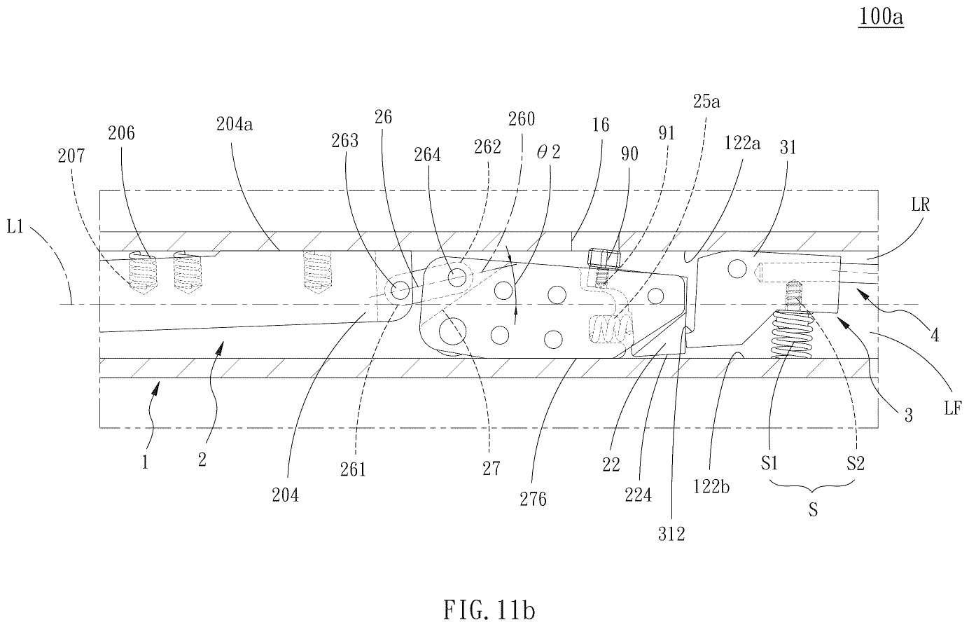

FIG. 11a illustrates wrenching operation of the digital-display torque wrench according to the second embodiment of the present invention, wherein the wrench has tripped;

FIG. 11b is a zoom-in view of a part of FIG. 11a;

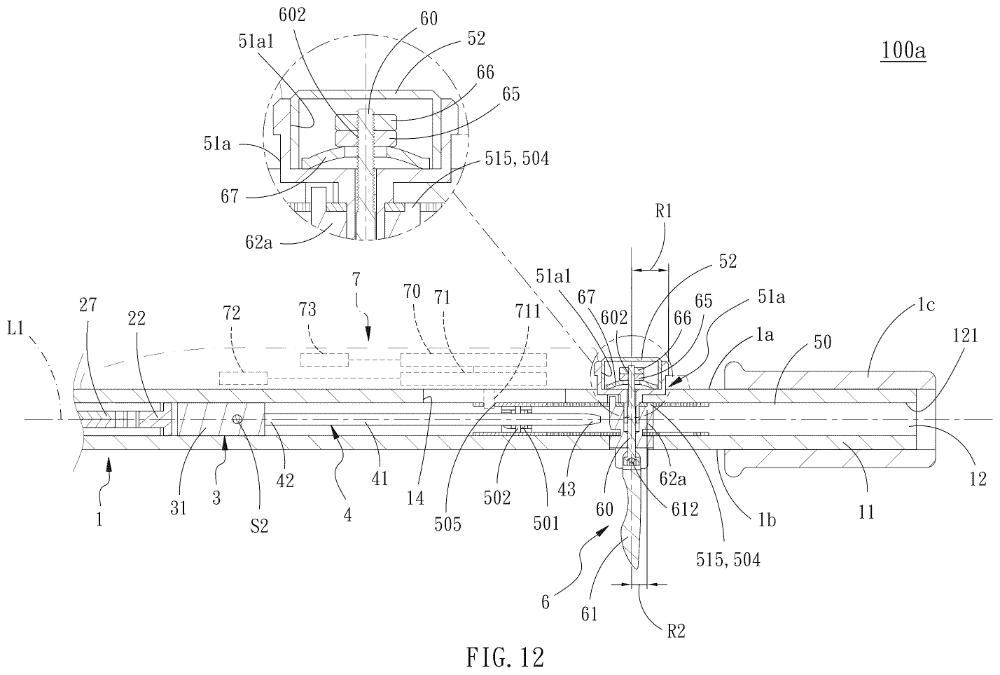

FIG. 12 is a longitudinal section of a part of the digital-display torque wrench of the present invention, showing that the locking device is in its releasing position, and the first force-transferring member now can drive the sliding member to perform linear displacement, thereby bringing the bearing portion to the upper limit;

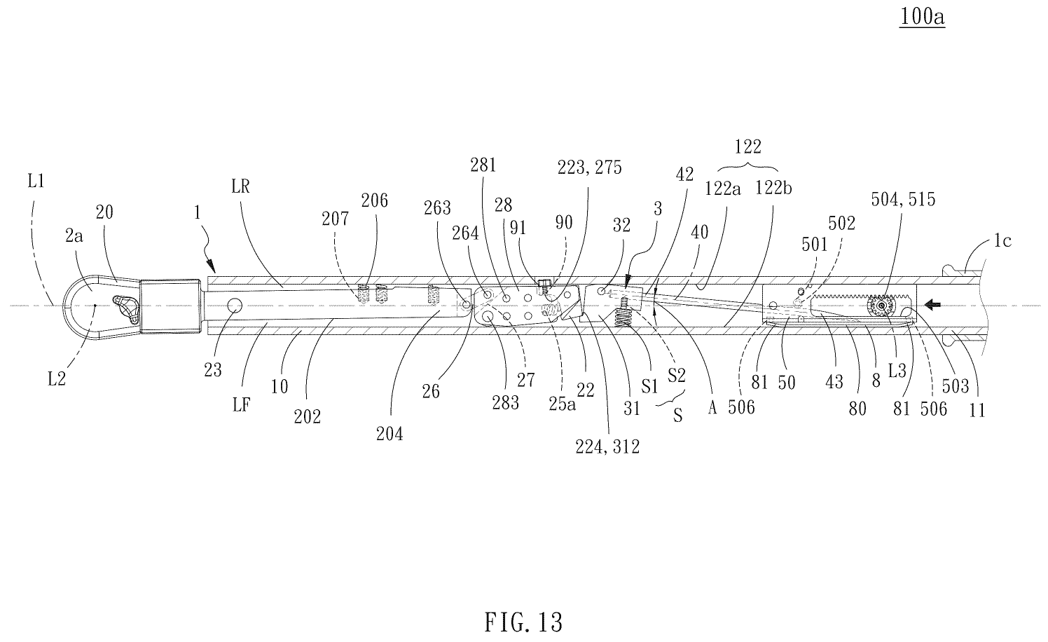

FIG. 13 is a cross section of a part of the digital-display torque wrench of the present invention, showing that the bearing portion is at the upper limit and the set torque value is at the maximum;

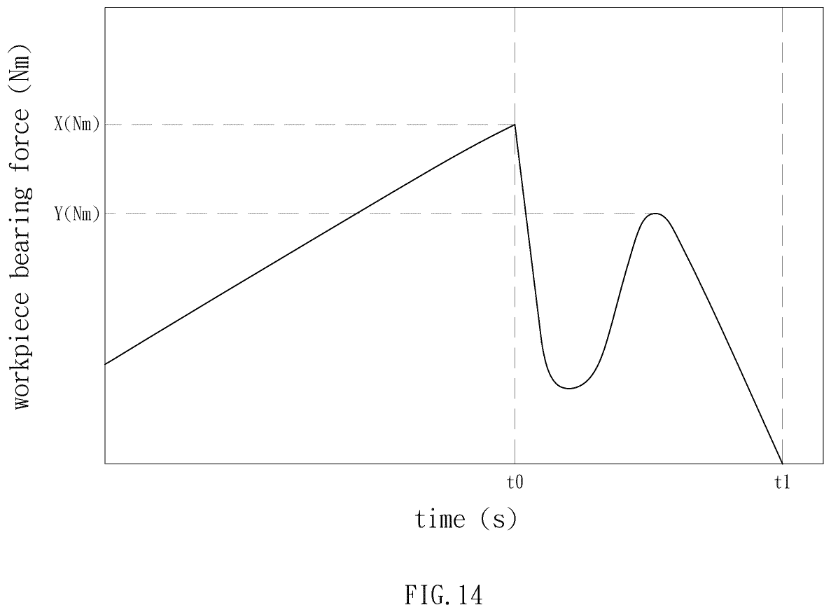

FIG. 14 is a graph showing variation of user force applied to the digital-display torque wrench of the present invention over time,

Therein: 100, 100a, digital-display torque wrench; 1, main body; 10, first end; 11, second end; 12, accommodating space; 121, guiding portion; 122, inner wall; 122a, first inner wall; 122b, second inner wall; 13, pivot hole; 14, sensing window; 15, through hole; 16, through hole; 17, pivot hole; 1a, top side; 1b, bottom side; 1c, handle; 2, wrenching device; 20, wrenching member; 201, socket; 202, connecting portion; 203, pivotal-connection hole; 204, terminal; 204a, first impacting surface; 204b, through hole; 205, first restricting portion; 206, elastic member; 207, receiving hole; 208, through hole; 209, receiving hole; 21, driving head; 210, adjusting hole; 211, plug; 22, abutting member; 221, through hole; 222, fixing pin; 223, second restricting portion; 224, first abutting portion; 225, fixing pin; 23, fixing pin; 25, restoring member; 25a, restoring member; 26, link; 260, centerline; 261, first connecting end; 261a, through hole; 262, second connecting end; 262a, through hole; 263, fixing pin; 264, fixing pin; 27, acting member; 271, through hole; 272, through hole; 273, acting end; 274, notch; 275, first restricting portion; 276, second impacting surface; 28, holding plate; 281, fixing pin; 282, through hole; 283, fixing pin; 284, through hole; 285, through hole; 2a, wrenching end; 3, torque-breaking device; 31, breaking member; 311, through hole; 312, second abutting portion; 32, fixing pin; 4, specially-shaped elastic member; 40, centerline; 41, trunk; 42, fixing end; 43, specially-shaped supporting segment; 431, curved contacting area; 5, torque-adjusting device; 50, sliding member; 501, bearing portion; 502, fixing pin; 503, adjusting slot; 504, first toothed portion; 505, pin bore; 506, through hole; 51, first force-transferring member; 511, first connecting end; 512, first pressing portion; 513, rotating end; 514, force-bearing portion; 515, second toothed portion; 516, non-circular shaft; 51a, first force-transferring member; 51a1, recess; 52, protective cap; 6, locking device; 60, axial shaft; 601, pivotal-connection hole; 602, threaded portion; 61, operating lever; 611, eccentric cam; 612, pivot; 62, second force-transferring member; 621, second connecting end; 622, second pressing portion; 623, second toothed portion; 62a, second force-transferring member; 63, force-transferring assembly; 631, block; 632, elastic sheet; 64, cover; 65, first screwing member; 66, second screwing member; 67, disc spring; 7, torque-sensing device; 70, display unit; 71, sensing member; 711, movable portion; 72, counter; 73, power source; 8, biasing device; 80, leaf spring; 81, hooking portion; 9, adjusting device; 90, adjusting member; 901, adjusting end; 902, abutting end; 91, nut; 911, bore; A, angle of inclination; B, impact angle; L1, axis; L2, rotational axis; L3, operational axis; LF, forward side; LR, rearward side; R1, first radius of rotation; R2, second radius of rotation; S, resilient device; S1, spring; S2, screw member; SP1, first impact space; SP2, second impact space; θ1, first included angle; θ2, first included angle.

### IMPLEMENTING THE PREFERRED EMBODIMENTS OF THE INVENTION

### Preferred Embodiments of the Invention

To make the foregoing objectives, features, and advantages of the present invention clearer and more understandable, the following description will be directed to some embodiments as depicted in the accompanying drawings to detail the technical schemes disclosed in these embodiments. It is, however, to be understood that the embodiments referred herein are only a part of all possible embodiments and thus not exhaustive. Based on the embodiments of the present invention, all the other embodiments can be conceived without creative labor by people of ordinary skill in the art, and all these and other embodiments shall be encompassed in the scope of the present invention.

Please refer to FIG. 1 through FIG. 7, in a first embodiment of the present invention, a digital-display torque wrench with mechanically adjustable torque 100 comprises a main body 1, a wrenching device 2, a torque-breaking device 3, a specially-shaped elastic member 4, a torque-adjusting device 5, a locking device 6, and a torque-sensing device 7.

The main body 1 defines an axis L1 and has a first end 10 and a second end 11 remote from the first end 10 along the axis L1. The axis L1 splits the main body 1 into a forward side LF and a rearward side LR. The main body 1 has an accommodating space 12. In the embodiment of the present invention, the main body 1 is a flat rectangular tube, and a guiding portion 121 is formed in the accommodating space 12. The main body 1 is further formed with a pivot hole 13, a sensing window 14, and a through hole 15 that are arranged in order from the first end 10 to the second end 11. The pivot hole 13, the sensing window 14, and the through hole 15 are communicated with the accommodating space 12, respectively, and the sensing window 14 is formed as a slot. Therein, the accommodating space 12 is defined by an inner wall 122. The inner wall 122 includes a first inner wall 122a at the rearward side LR and a second inner wall 122b at the forward side LF.

The wrenching device 2 is swingably connected to the first end 10 of the main body 1. The wrenching device 2 has a wrenching end 2a exposed outside the main body 1. The wrenching end 2a defines a rotational axis L2. When the digital-display torque wrench 100 performs wrenching operation, the main body 1 rotates about the rotational axis L2 to wrench a fastening member. Therein, the rotational axis L2 is perpendicular to the axis L1. In the embodiment of the present invention, the wrenching device 2 comprises a wrenching member 20, a driving head 21, and an abutting member 22. The wrenching end 2a is located at one end of the driving head 21 while the opposite end of the driving head 21 is detachably connected to the wrenching member 20. As shown in FIG. 2, the wrenching member 20 has a socket 201, and the driving head 21 has a plug 211. Provided that the contour complementation between the socket 201 and the plug 211 is achieved, driving heads 21 of different specifications may be selected to use with the wrenching member 20 according to practical needs.

The wrenching member 20 is attached to and swingable with respect to the first end 10 of the main body 1. The wrenching member 20 has a connecting portion 202 remote from the socket 201. The wrenching member 20 is pivotally connected to the first end 10 of the main body 1 by a fixing pin 23 that passes through the pivot hole 13 of the main body 1 and the pivotal-connection hole 203 of the wrenching member 20. The connecting portion 202 extends into the main body 1 with its terminal 204 remote from the wrenching end 2a. The terminal 204 has one side formed with a first restricting portion 205. An elastic member 206 is installed between the connecting portion 202 and the first inner wall 122a of the main body 1. The elastic member 206 has its one end abutting against the first inner wall 122a and has its opposite end received in a receiving hole 207 formed at the corresponding lateral of the wrenching member 20 so as to provide a force that returns the wrenching member 20 to its idle state.

The abutting member 22 is pivotally connected to the end of the wrenching device 2 opposite to the wrenching end 2a. In the embodiment of the present invention, the abutting member 22 is formed with a through hole 221 and is pivotally connected to the terminal 204 by a fixing pin 222 that also passes through a through hole 208 formed on the terminal 204. The abutting member 22 has its one lateral facing the terminal 204 provided with a second restricting portion 223 and has its opposite lateral provided with a first abutting portion 224. The first restricting portion 205 and the second restricting portion 223 are configured to abut against each other so as to define the swinging extent of the abutting member 22.

The torque-breaking device 3 is pivotally accommodated in the accommodating space 12 of the main body 1 and is configured to selectively abut against the end of the wrenching device 2 remote from the wrenching end 2a. This allows the torque-breaking device 3 and the wrenching device 2 abut against each other. In the embodiment of the present invention, the torque-breaking device 3 selectively abuts against the abutting member 22 of the wrenching device 2. The torque-breaking device 3 comprises a breaking member 31. The breaking member 31 is pivotally connected to the main body 1 by a fixing pin 32 that passes through a through hole 311 and thereby abuts against the abutting member 22 in a way that the breaking member 31 can swing between a first position and a second position with respect to the main body 1.

As the wrenching force from the digital-display torque wrench 100 increases and reaches the set torque value, the breaking member 31 disengages from the abutting member 22 to thereby stop the digital-display torque wrench 100 from further exerting force (as shown in FIG. 4). After the digital-display torque wrench 100 is returned to its idle state, the abutting engagement between the breaking member 31 and the abutting member 22 restores automatically (as shown in FIG. 5). In the embodiment of the present invention, the breaking member 31 at its lateral opposite to the specially-shaped elastic member 4 has a second abutting portion 312 for abutting against the first abutting portion 224 of the abutting member 22. Additionally, the wrenching device 2 further comprises a restoring member 25. The restoring member 25 is arranged between a receiving hole 209 of the terminal 204 and the abutting member 22. The restoring member 25 may be a spring that normally makes the abutting member 22 and the torque-breaking device 3 abut against each other.

The specially-shaped elastic member 4 is such installed in the main body 1 that it is inclined with respect to the axis L1 of the main body 1. The specially-shaped elastic member 4 has a centerline 40 that forms an angle of inclination A with the axis L1. The specially-shaped elastic member 4 has one end fixed to the breaking member 31 of the torque-breaking device 3. In the embodiment of the present invention, the specially-shaped elastic member 4 is shaped as a stick and has a trunk 41 extending along the centerline 40. The trunk 41 has one end formed as a fixing end 42 and has the end opposite to the fixing end 42 formed with a specially-shaped supporting segment 43. The specially-shaped supporting segment 43 has a curved contacting area 431. The fixing end 42 is located at the forward side LF of the main body 1 and fixed to the breaking member 31 of the torque-breaking device 3 at the lateral opposite to the abutting member 22. The specially-shaped supporting segment 43 of the specially-shaped elastic member 4 is able to cross the axis L1 of the main body 1.

The torque-adjusting device 5 is assembled to the main body 1. The torque-adjusting device 5 has a sliding member 50 that is slidably installed in the guiding portion 121 of the main body 1 so that it can slide in a direction parallel to the axis L1. The sliding member 50 is in the form of a frame, in which a bearing portion 501 is rotatably provided. The bearing portion 501 is a roller for the specially-shaped supporting segment 43 of the specially-shaped elastic member 4 to abut against, so that the curved contacting area 431 and the bearing portion 501 are in rolling contact. In the embodiment of the present invention, the bearing portion 501 is pivotally connected to the sliding member 50 by a fixing pin 502. Adjustment of the axial location of the bearing portion 501 of the sliding member 50 with respect to the specially-shaped supporting segment 43 changes the contacting area between the first abutting portion 224 and the second abutting portion 312.

Moreover, the sliding member 50 is formed with an adjusting slot 503. The adjusting slot 503 has its inner edge provided with a first toothed portion 504. The first toothed portion 504 linearly extends in a direction parallel to the axis L1. The specially-shaped supporting segment 43 of the specially-shaped elastic member 4 is inserted into the sliding member 50, so that the bearing portion 501 and the specially-shaped supporting segment 43 abut against each other. Thereby, displacement of the sliding member 50 makes the bearing portion 501 move and in turn changes where the bearing portion 501 abuts against and supports the specially-shaped supporting segment 43 of the specially-shaped elastic member 4.

Therein, when the bearing portion 501 of the torque-adjusting device 5 abuts against the curved contacting area 431 of the specially-shaped elastic member 4 at a location farthest from the fixing end 42, the set torque value is minimum (as shown in FIG. 4). When the bearing portion 501 of the torque-adjusting device 5 abuts against the curved contacting area 431 of the specially-shaped elastic member 4 at a location closest to the fixing end 42, the set torque value is maximum (as shown in FIG. 7). Since the torque-adjusting device 5 is for a user to operate to easily adjust the axial location of the bearing portion 501 with respect to the specially-shaped supporting segment 43 and to thereby change the angle of inclination A of the specially-shaped elastic member 4 with respect to the main body 1, when the set torque value is minimum, the angle of inclination A of the specially-shaped elastic member 4 is minimum, and the swinging extent of the breaking member 31 with respect to the main body 1 is small. Consequently, the contacting area between the first abutting portion 224 of the abutting member 22 and the second abutting portion 312 of the breaking member 31 is small. When the set torque value is maximum, the angle of inclination A of the specially-shaped elastic member 4 is maximum, and the swinging extent of the breaking member 31 with respect to the main body 1 is large. Consequently, the contacting area between the first abutting portion 224 of the abutting member 22 and the second abutting portion 312 of the breaking member 31 is large. This leads to strengthened engagement between the breaking member 31 and the abutting member 22, which means disengagement between the two components requires increased wrenching torque. In this way, the set torque value of the digital-display torque wrench 100 can be increased, thereby raising the upper limit and extending the range of the set torque value.

The locking device 6 is assembled between the sliding member 50 and the main body 1. The locking device 6 is configured to be switched between a releasing position and a locking position. When it is in the releasing position, the axial location of the bearing portion 501 of the sliding member 50 can be easily adjusted with respect to the specially-shaped elastic member 4, so as to adjust the torque of the digital-display torque wrench 100. When it is in the locking position, the locking device 6 results in frictional resistance between the sliding member 50 and the main body 1, so that the sliding member 50 is prevented from moving with respect to the main body 1. In the embodiment of the present invention, when it is in the releasing position, the sliding member 50 can be rotated about an operational axis L3 that is parallel to the rotational axis L2 and perpendicular to the axis L1 so as to adjust the location of the sliding member 50 along the axis L1. The locking device 6 is in connection with the torque-adjusting device 5 along the operational axis L3. When it is in the locking position, the locking device 6 results in frictional resistance to the sliding member 50 along the operational axis L3, so as to make the locking device 6 hold the sliding member 50 and the main body 1 firmly, thereby securing the locking relationship between the main body 1 and the sliding member 50 (as shown in FIG. 3), and preventing the sliding member 50 from moving with respect to the main body 1. Since the locking device 6 is connected to the torque-adjusting device 5, the two components form a combined structure, making the overall structural layout of the disclosed torque wrench more compact.

In the embodiment of the present invention, the main body 1 has a top side 1a and an opposite bottom side 1b along the operational axis L3. The torque-adjusting device 5 further comprises a first force-transferring member 51 that drives the sliding member 50 to move. The first force-transferring member 51 has a first connecting end 511 at one end, a first pressing portion 512, and a rotating end 513 remote from the first connecting end 511. The rotating end 513 is formed in a circular rotary disc shape and has a first radius of rotation R1. Additionally, the first force-transferring member 51 has a force-bearing portion 514 remote from the first pressing portion 512.

The locking device 6 comprises an axial shaft 60 that passes through the through hole 15 of the main body 1 and the sliding member 50 along the operational axis L3, an operating lever 61 swingably attached to one end of the axial shaft 60, and a second force-transferring member 62 screwedly connected to the axial shaft 60. The axial shaft 60 has one end formed with a pivotal-connection hole 601 and exposed outside the main body 1 at the top side 1a. The operating lever 61 has an eccentric cam 611. The operating lever 61 is pivotally connected to the axial shaft 60 at the pivotal-connection hole 601 by a pivot 612, so that the operating lever 61 can be operated by the user to selectively swing with respect to the axial shaft 60, and the operating lever 61 drives the axial shaft 60 to move along the operational axis L3. The first force-transferring member 51 and the second force-transferring member 62 are both installed on the axial shaft 60. The first force-transferring member 51 is rotatably installed on the main body 1 and the axial shaft 60 along the operational axis L3 and is interlocked with the second force-transferring member 62 in terms of movement. In the locking position, the operating lever 61 can pull the axial shaft 60 along the operational axis L3 and drive the first force-transferring member 51 and the second force-transferring member 62 to push toward each other, thereby holding the main body 1 and the sliding member 50 firmly therebetween (as shown in FIG. 3). In the releasing position, the operating lever 61 is released with respect to the axial shaft 60, so that the user can operate the first force-transferring member 51 to drive the sliding member 50 to slide linearly with respect to the main body 1 (as shown in FIG. 6).

In the first embodiment, the operating lever 61 is located at the top side 1a of the main body 1, so that the user can operate the locking device 6 at the top side 1a of the digital-display torque wrench 100. The second force-transferring member 62 has a second connecting end 621 and a second pressing portion 622 located in the sliding member 50. The second connecting end 621 is connected to and synchronously moves with the first connecting end 511. In the locking position, the first pressing portion 512 presses on the main body 1, and the second pressing portion 622 presses on the sliding member 50, so as to hold and lock the two components firmly. Therein, the first connecting end 511 and the second connecting end 621 such engage with each other that relative rotation therebetween is prevented by means of, for example, complementary fitting. Thereby, the locking device 6 can lock the main body 1 and the sliding member 50 together to achieve structural compactness, which helps prevent jiggling during operation of the wrench and lead to precise, non-distortion torque performance.

The second force-transferring member 62 has a second toothed portion 623 that is located between the second connecting end 621 and the second pressing portion 622 and around the operational axis L3. The second toothed portion 623 engages with the first toothed portion 504 of the sliding member 50. Therein, the second force-transferring member 62 has a second radius of rotation R2, and the second toothed portion 623 extends along the second radius of rotation R2. The first radius of rotation R1 is greater than the second radius of rotation R2. Thereby, the user can rotate the first force-transferring member 51 and drive the second force-transferring member 62 with less effort, and then make the second force-transferring member 62 drive the sliding member 50 to move with respect to the main body 1, thereby achieving rapid adjustment of the upper or lower limit of the set torque value.

In the embodiment of the present invention, the locking device 6 comprises a force-transferring assembly 63, which abuts between the eccentric cam 611 of the operating lever 61 and the force-bearing portion 514 of the first force-transferring member 51. The force-transferring assembly 63 comprises a block 631 and an elastic sheet 632. In the locking position, the eccentric cam 611 of the operating lever 61 exerts force on the force-transferring assembly 63, so that the force-transferring assembly 63 transfers the force to the first force-transferring member 51. In the releasing position, the elastic sheet 632 acts to return the block 631 to its original position. Additionally, the locking device 6 has a cover 64 that covers the first force-transferring member 51 and is located remote from the second force-transferring member 62, so as to hold the block 631 firmly.

The torque-sensing device 7 is installed on the main body 1 and near the torque-adjusting device 5. The torque-sensing device 7 serves to sense adjustment made to the torque-adjusting device 5 and display the set torque value, thereby informing the user of the set torque value in an intuitive manner. In the embodiment of the present invention, the torque-sensing device 7 includes a display unit 70, a sensing member 71, a counter 72, and a power source 73 that are electrically connected to each other. Therein, the torque-sensing device 7 is located at the top side 1a of the main body 1, and the power source 73 is a battery installed in the second end 11 of the main body 1 to power the display unit 70, the sensing member 71, and the counter 72.

The sensing member 71 is locationally aligned with the sensing window 14. The sensing member 71 has a movable portion 711. The movable portion 711 is inserted into and moves with a pin bore 505 of the sliding member 50, so that the sensing member 71 can sense locational change of the sliding member 50 through the sensing window 14 and accordingly generate a torque signal. The display unit 70 displays the set torque value according to the torque signal. Therein, the sensing member 71 is a variable resistor.

The counter 72 is such located to be aligned with the abutting member 22 of the torque-breaking device 3 so that it can send a counting signal according to the number of times of disengagement between the breaking member 31 and the abutting member 22 and make the counting signal displayed at the display unit 70. Thereby, the user can be informed that how many times the digital-display torque wrench 100 has exceeded the set torque value and then fasten the fastening member to a more relevant torque value precisely.

In addition, according to the present invention, the main body 1 further comprises a handle 1c, which is mounted around the second end 11 of the main body 1 for the user to hold when operating the wrench.

The wrench of the present invention further comprises a biasing device 8, which is arranged between the main body 1 and the sliding member 50. The biasing device 8 comprises a strip-shaped leaf spring 80, which is installed between the main body 1 and the sliding member 50 and is parallel to the axis L1. The leaf spring 80 applies a spring force to the sliding member 50 in a direction perpendicular to the axis L1 and the operational axis L3, so as to eliminate the clearance between the sliding member 50 and the main body 1. Therein, the leaf spring 80 has its two ends each provided with a hooking portion 81. Each of the hooking portions 81 hooks a through hole 506 at the corresponding lateral of the sliding member 50, so that the leaf spring 80 is combined and moves with the sliding member 50.

In the present invention, the wrenching device 2 further comprises an adjusting device 9, which is used to adjust how strongly the wrenching device 2 and the torque-breaking device 3 abut against each other, thereby adjusting the wrench in terms of torque precision. In the embodiment of the present invention, the adjusting device 9 is arranged between the terminal 204 of the wrenching member 20 and the abutting member 22. The adjusting device 9 comprises an adjusting member 90 and a nut 91 screwed to one end of the adjusting member 90. The adjusting member 90 and the nut 91 are inserted into the main body 1 through a through hole 16 at a lateral of the main body 1, and the adjusting member 90 has its opposite end screwed into an adjusting hole 210 formed on the terminal 204. The adjusting member 90 has an adjusting end 901 and an abutting end 902. The nut 91 has a bore 911. The abutting end 902 is exposed at the adjusting hole 210 and abuts against the abutting member 22. Before shipment of the wrench or for maintenance of the wrench, it is possible to set the swinging range of the abutting member 22 with respect to the terminal 204 by accessing the adjusting end 901 using a hand tool through the through hole 16 and the bore 911 of the nut 91. This in turn changes the contacting area across which the first abutting portion 224 of the abutting member 22 abuts against the second abutting portion 312 of the breaking member 31.

The present invention further comprises a resilient device S, which comprises a spring S1 and a screw member S2. The screw member S2 is screwed into a lateral of the breaking member 31. The spring S1 has one end connected to the screw member S2 and an opposite end abutting against the first inner wall 122a. The spring S1 of the resilient device S serves to ensure that the curved contacting area 43 of the specially-shaped elastic member 4 is always in contact with the bearing portion 501 of the sliding member 50.

As shown in FIG. 6 and FIG. 7, when the locking device 6 is in the releasing position, the user can rotate the first force-transferring member 51 to adjust the set torque value. Specifically, the first force-transferring member 51 when rotating drives the second force-transferring member 62 to rotate and in turn drives the sliding member 50 to move linearly in the axis L1 with respect to the main body 1 toward the breaking member 31, thereby moving the bearing portion 501 from the lower limit to the upper limit rapidly. At this time, the bearing portion 501 supports at the specially-shaped supporting segment 43 of the specially-shaped elastic member 4 and moves from the distal to the center. Here is the place where the set torque value of the digital-display torque wrench 100 is set as the maximum. Since the first radius of rotation R1 is greater than the second radius of rotation R2, the adjustment can be rapidly achieved by rotating the first force-transferring member 51 for only 1˜2 turns, making the use convenient and easy. Now the breaking member 31 is in the first position, and the first force-transferring member 51 can be rotated by the user to drive the sliding member 50 to adjust the location of the bearing portion 501 with respect to the specially-shaped supporting segment 43. In this way, adjustment of torque from the minimum to the maximum can be accomplished rapidly and simply. When it is desired to return the wrench to the position as shown in FIG. 3 and FIG. 4, adjustment of torque from the maximum to the minimum can also be accomplished rapidly and simply through the foregoing process.

Still referring to FIG. 7, when operating the digital-display torque wrench 100 with the set torque value at the maximum, bending generated at the part of the specially-shaped elastic member 4 between the fixing end 42 and the bearing portion 501 due to the counterforce of the wrenching device 2 the part receives is smaller than that generated when the set torque value is at the minimum. When the wrenching force of the digital-display torque wrench 100 is greater than the set value, as described previously, the breaking member 31 disengages from the abutting member 22 to break transmission of the force exerted by the digital-display torque wrench 100, thereby advising the user that it is better to stop application of force or the fastening member may get damaged. By operating the torque-adjusting device 5 as described above, the sliding member 50 can be moved rapidly along the direction parallel to the axis L1, thereby achieving fast adjustment of torque.

Please refer to FIG. 8 through FIG. 14. In a second embodiment of the present invention, a digital-display torque wrench 100a is similar to that of the first embodiment. To highlight the differences between the two embodiments, their similarities will not be described in any length. The operating lever 61 in the second embodiment is located at the bottom side 1b of the main body 1 for a user to operate the locking device 6 from the bottom side 1b of the digital-display torque wrench 100. The following differences also feature the second embodiment.

The main body 1 is further provided with a pivot hole 17 that is located between the pivot hole 13 and the through hole 15, and is communicated with the accommodating space 12.

The wrenching device 2 further comprises a link 26, an acting member 27, and two holding plates 28. The wrenching member 20 has a first impacting surface 204a at the side of the terminal 204. A first impact space SP1 is formed between the first impacting surface 204a and the first inner wall 122a. The link 26 has a first connecting end 261 and an opposite second connecting end 262. In the embodiment of the present invention, the first connecting end 261 of the link 26 is pivotally connected to the terminal 204 by a fixing pin 263 passing through a through hole 204b of the terminal 204 and a through hole 261a of the link 26.

At two sides of the two holding plates 28, four fixing pins 281 pass through through holes 282 of the two holding plates 28 and a through hole 271 of the acting member 27, respectively, to hold the two holding plates 28 and the acting member 27 together. The second connecting end 262 of the link 26 is pivotally connected to one side of the two holding plates 28 by a fixing pin 264 passing through a through hole 262a. Additionally, in the second embodiment, there are two acting members 27, and the two acting members 27 are sandwiched between and stacked with the two holding plates 28 to be combined together.

The two acting members 27 and the two holding plates 28 are pivotally connected to the main body 1 by a fixing pin 283 that passes through the pivot hole 17, through holes 284 of the two holding plates 28, and a through hole 272 of the acting member 27, so that the acting member 27 can swing between a first swinging position and a second swinging position with respect to the main body 1, and then the acting member 27 is interlocked with the second connecting end 262 of the link 26. Consequently, when the wrenching member 20 swings, the link 26 pulls the two holding plates 28 to move, and the two holding plates 28 in turn pull the two acting members 27 to swing. Moreover, each of the acting members 27 has an acting end 273 remote from the link 26. The acting end 273 is formed with a notch 274 and a first restricting portion 275. The first restricting portion 275 is remote from the wrenching end 2a. Furthermore, the acting member 27 has one lateral formed as a second impacting surface 276. A second impact space SP2 is formed between the second impacting surface 276 and the second inner wall 122b.

In the second embodiment, the abutting member 22 contacts and is interlocked with the acting end 273 of the acting member 27 by a fixing pin 225 that passes through through holes 285 at the opposite side of the two holding plates 28. The second restricting portion 223 of the abutting member 22 and the first restricting portion 275 of the acting member 27 abut against each other, so as to limit the swinging range of the abutting member 22.

In the second embodiment, a restoring member 25a is received by the notch 274 and is located between the acting members 27 and the abutting member 22 to make the abutting member 22 and the breaking member 31 abut against each other normally. There are three elastic members 206 arranged between the wrenching member 20 and the main body 1 to provide a force that returns the wrenching member 20 to its idle state.

A first force-transferring member 51a of the torque-adjusting device 5 has a second toothed portion 515 around the operational axis L3 remote from the first pressing portion 512 to engage with the first toothed portion 504 of the sliding member 50. Therein, the second toothed portion 515 is a gear that is fixed to a non-circular shaft 516 of the first force-transferring member 51a. The first force-transferring member 51a has a recess 51a1 for a protective cap 52 to cap thereon.

In the locking device 6, a second force-transferring member 62a has the second connecting end 621 slidably connected to the non-circular shaft 516 of the first force-transferring member 51a. Similar to its counterpart in the first embodiment, the locking device 6 in the second embodiment is also configured to selectively hold the sliding member 50 and the main body 1 together to lock the main body 1 and the sliding member 50 stably. Therein, in the locking position, the eccentric cam 611 of the operating lever 61 applies a force on the second force-transferring member 62a to make the second force-transferring member 62a and the first force-transferring member 51a press toward each other, thereby holding the main body 1 and the sliding member 50 together.

Furthermore, the axial shaft 60 of the locking device 6 has a threaded portion 602 passing through the first force-transferring member 51a to enter the recess 51a1, and then a first screwing member 65 and a second screwing member 66 are screwed onto the threaded portion 602. Therein, a disc spring 67 is provided between the first screwing member 65 and the first force-transferring member 51a to absorb vibration and prevent the first screwing member 65 and the second screwing member 66 from coming off the axial shaft 60.

In the second embodiment, the adjusting device 9 is arranged between the acting member 27 and the abutting member 22. The adjusting member 90 is screwed into the abutting member 22 and abuts against the acting member 27, so as to adjust the swinging range of the abutting member 22 with respect to the acting member 27, thereby achieving the same result as adjusting the contacting area between the abutting member 22 and the breaking member 31 as described in the first embodiment.

Please refer to FIG. 9, FIG. 10a, and FIG. 10b. As shown in FIG. 9, the bearing portion 501 is at the lower limit. Here, the bearing portion 501 supports at the distal of the specially-shaped supporting segment 43 of the specially-shaped elastic member 4 and is farthest from the wrenching end 2a. In this way, the set torque value of the digital-display torque wrench 100 is set at the minimum, and the breaking member 31 is also in the first position. As shown in FIG. 10b, when the digital-display torque wrench 100 is in the idle state, a centerline 260 of the link 26 and the axis L1 include a first included angle θ1. The second impacting surface 276 and the axis L1 include an impact angle B. The second connecting end 262 of the link 26 is located at the rearward side LR. The first included angle 01 is greater than the impact angle B.

Then, as shown in FIG. 11a, FIG. 11b, and FIG. 14, when the digital-display torque wrench 100 is operated and the acting member 27 is in the first swinging position, the acting member 27 transfers the counterforce of the wrenching device 2 to the specially-shaped elastic member 4, so that the part of the specially-shaped elastic member 4 between the fixing end 42 and the bearing portion 501 bends. When the wrenching force of the digital-display torque wrench 100 is greater than the set torque value, the breaking member 31 disengages from the abutting member 22 to break transmission of the force exerted by the digital-display torque wrench 100, thereby making the acting member 27 swings from the first swinging position to the second swinging position. At this time, the acting member 27 drives the link 26 to move with respect to the main body 1, and makes the acting member 27 and the wrenching member 20 to hit the first inner wall 122a and the second inner wall 122b of the main body 1 at the same time. Upon such impact, the first impacting surface 204a of the wrenching member 20 enters the first impact space SP1 to hit the first inner wall 122a, and the second impacting surface 276 of the acting member 27 enters the second impact space SP2 to hit the second inner wall 122b, thereby generating obvious feeling of mechanical torque tripping in the hand of the user to advise the user to stop exerting force. Also, since the link 26 and the acting member 27 such arranged between the wrenching member 20 and the breaking member 31 that they are interlocked, when the breaking member 31 is able to disengage from the abutting member 22, the link 26 can instantly covert the pushing force from the wrenching member 20 it has received till now into a pulling force that pulls the wrenching member 20. This pulling force defers the time on which the wrenching member 20 hits the first inner wall 122a. It is usual that a user wrenching a fastening member with the wrench can continue exerting the operating force due to inertia even after the wrenching operation has reached the set torque value, which is herein referred to as inertial application of force. The present invention thus uses the interlocked structure around the link 26 to buffer such an inertially applied force and prevent excessive torque from acting on the fastening member, thereby achieving more precise wrenching operation. Accordingly, once the wrench reaches the set torque value and the peak X(Nm) appears, in the following 1 second (as shown in the time interval between t0 and t1 in FIG. 14), the sub-peak Y(Nm) generated due to the inertial force application by the user is smaller than the peak X(Nm), so as to prevent undue application of torque on the fastening member, as shown in FIG. 14.

Moreover, as shown in FIG. 11b, when the torque-breaking device 3 breaks the application of force of the digital-display torque wrench 100, the centerline 260 of the link 26 and the axis L1 jointly include a second included angle θ2. The first included angle θ1 is greater than the second included angle θ2, and the first connecting end 261 of the link 26 can cross the axis L1 of the main body 1 to be in the rearward side LR of the main body 1 together with the second connecting end 262. As described previously, the breaking member 31 is in the second position, and the specially-shaped elastic member 4 enables the torque-breaking device 3 to provide the wrenching device 2 with a restoring force. When the wrenching force of the digital-display torque wrench 100 is smaller than the set torque value, the abutting member 22 and the breaking member 31 return to the state that they abut against each other.

Then referring to FIG. 12 and FIG. 13, the locking device 6 is now in the releasing position, so that the user can operate the torque-adjusting device 5 to adjust the set torque value. Specifically, with rotation of the first force-transferring member 51 that derives the second force-transferring member 62 to rotate, the sliding member 50 is driven to perform linear movement with respect to the main body 1 along the axis L1 toward the breaking member 31, thereby rapidly moving the bearing portion 501 from the lower limit to the upper limit. When it is desired to return the wrench to the position as shown in FIG. 9 and FIG. 10a, adjustment of torque from the maximum to the minimum can also be accomplished rapidly and simply through the foregoing process.

To sum up, the present invention has the following advantages:
1. With the locking device 6 in the locking position that locks the main body 1 and the sliding member 50 together, the increased frictional resistance therebetween prevents the sliding member 50 from moving with respect to the main body 1, so that no jigging will happen during operation of the wrench, thereby ensuring more precise, non-distortion torque performance.
2. With the clearance between the sliding member 50 and the main body 1 eliminated by the biasing device 8, tight fitting between the two components can be achieved and contribute to high precision of the wrench in terms of torque performance.
3. With the adjusting device 9 configured to adjust the swinging range of the abutting member 22, it is possible to adjust the contacting area between the abutting member 22 and the breaking member 31 before shipment of the wrench or for maintenance of the wrench, thereby ensuring precision of the wrench in terms of torque.
4. The interlocking relationship among the wrenching member 20, the link 26, and the acting member 27 can generate obvious feeling of mechanical torque tripping in the hand of the user to not only advise the user to stop exerting force but also buffer the inertial force application after the wrenching operation of the user against a fastening member has exceeded the set torque value, so as to prevent undue application of torque on the fastening member.

It is to be noted that in the disclosure the terms such as “first” and “second” are intended to differentiate one entity or operation from another similar entity or operation, and by no means require or imply any relationship or sequence between these entities or operations. Furthermore, the term “comprise,” “include” or any variation thereof is meant to comprehend non-exclusive inclusion, thereby making any process, method, article, or device comprising a series of essential elements include not only these essential elements but also other elements that are not enumerated, or any element known to be necessary to the process, method, article, or device.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

1. A digital-display torque wrench with mechanically adjustable torque, comprising:
a main body, defining an axis along which a first end and a second end remote from the first end are formed;
a wrenching device, being swingably attached to the first end of the main body, and comprising a wrenching end exposed outside the main body;
a torque-breaking device, being pivotally connected in the main body and configured to selectively abut against one end of the wrenching device that is remote from the wrenching end;
a specially-shaped elastic member, comprising a fixing end and a specially-shaped supporting segment different from the fixing end, wherein the fixing end of the specially-shaped elastic member is fixed to the torque-breaking device;
a torque-adjusting device, being assembled to the main body, and having a sliding member, wherein the sliding member is installed in the main body to be slidable along a direction parallel to the axis and has a bearing portion, in which the bearing portion configured to abut against the specially-shaped supporting segment of the specially-shaped elastic member;
a locking device, being assembled between the sliding member and the main body, and configured to be operated between a releasing position and a locking position, wherein when the locking device is in the releasing position, an axial location of the bearing portion of the sliding member with respect to the specially-shaped elastic member is adjustable, and when the locking device is in the locking position, the locking device results in a frictional resistance between the sliding member and the main body, thereby preventing the sliding member from moving with respect to the main body; and
a torque-sensing device, being installed on the main body and aligned with the torque-adjusting device so as to sense a locational change of the sliding member and display a set torque value.

2. The digital-display torque wrench of claim 1, wherein the wrenching end defines a rotational axis, and when being operated for wrenching, the main body rotates about the rotational axis, in which when the locking device is in the releasing position, the locking device can be rotated about an operational axis that is parallel to the rotational axis and perpendicular to the axis, so as to make the locational change of the sliding member along the axis; the locking device being in connection with the torque-adjusting device along the operational axis; when being in the locking position, the locking device presses the sliding member along the operational axis, so as to result in the frictional resistance and hold the sliding member and the main body together tightly.

3. The digital-display torque wrench of claim 2, wherein the torque-adjusting device comprises a first force-transferring member configured to drive the sliding member to have the locational change, and the locking device comprises an axial shaft passing through the main body and the sliding member along the operational axis, an operating lever swingably attached to one end of the axial shaft, and a second force-transferring member provided on the axial shaft, in which the operating lever drives the axial shaft to move along the operational axis, and the first force-transferring member and the second force-transferring member are installed on the axial shaft, so that when the locking device is in the locking position, the operating lever pulls the axial shaft along the operational axis to make the first force-transferring member and the second force-transferring member press against each other, thereby holding the main body and the sliding member together tightly, and when the locking device is in the releasing position, the operating lever is released with respect to the axial shaft, so as to be rotated to operate the first force-transferring member and in turn drive the sliding member to slide linearly with respect to the main body.

4. The digital-display torque wrench of claim 3, wherein the wrenching device has an adjusting device, which is used to adjust an abutting level between the wrenching device and the torque-breaking device.

5. The digital-display torque wrench of claim 3, wherein the main body has a top side and a bottom side opposite to each other along the operational axis, in which the axial shaft is exposed outside the main body at the top side for the operating lever to be pivotally connected thereto; the first force-transferring member having a first connecting end and a first pressing portion, the second force-transferring member having a second connecting end and a second pressing portion that is located in the sliding member, the second connecting end being connected to and moving with the first connecting end; and when the locking device is in the locking position, the first pressing portion presses on the main body, and the second pressing portion presses on the sliding member.

6. The digital-display torque wrench of claim 5, wherein the first force-transferring member has a force-bearing portion that is remote from the first pressing portion, and the operating lever has an eccentric cam, while the locking device comprises a force-transferring assembly that abuts between the eccentric cam and the force-bearing portion, whereby when the locking device is in the locking position, the eccentric cam applies a force on the force-transferring assembly, and the force-transferring assembly transfers the force to the first force-transferring member; the sliding member having a first toothed portion extending in a direction parallel to the axis, the second force-transferring member having a second toothed portion that is located between the second connecting end and the second pressing portion and about the operational axis, the second toothed portion and the first toothed portion engaging with each other, the first force-transferring member being rotatably installed on the main body and the axial shaft to be rotatable about the operational axis and interlocked with the second force-transferring member in terms of movement, so that when rotated, the first force-transferring member drives the second force-transferring member and in turn drives the sliding member to perform displacement with respect to the main body, the first force-transferring member having a rotating end that is remote from the first connecting end, the rotating end having a first radius of rotation, the second force-transferring member having a second radius of rotation, the second toothed portion being arranged along the second radius of rotation, the first radius of rotation being greater than the second radius of rotation; the first connecting end and the second connecting end engaging with each other by means of complementary fitting.

7. The digital-display torque wrench of claim 3, further comprising a biasing device, which is arranged between the main body and the sliding member, and applies a spring force to the sliding member along a direction perpendicular to the axis and the operational axis, wherein the biasing device comprises a leaf spring, whose two ends each have a hooking portion to hook a corresponding lateral of the sliding member.

8. The digital-display torque wrench of claim 4, wherein the wrenching device comprises a wrenching member and an abutting member, the wrenching member being pivotally connected to the first end, the wrenching member having a terminal inserted into the main body, the abutting member being pivotally connected to the terminal, the torque-breaking device selectively abutting against the abutting member, the specially-shaped supporting segment having a curved contacting area for the bearing portion to abut thereagainst, the specially-shaped elastic member being installed in the main body and inclined with respect to the axis of the main body; when the bearing portion of the torque-adjusting device abuts against the curved contacting area of the specially-shaped elastic member at a site that is farthest from the fixing end, the set torque value being at the minimum, and when the bearing portion of the torque-adjusting device abuts against the curved contacting area of the specially-shaped elastic member at a site that is closest to the fixing end, the set torque value being at the maximum; when a wrenching force applied by the digital-display torque wrench increases and becomes equal to the set torque value, the torque-breaking device disengaging from the abutting member to break application of the wrenching force; when the digital-display torque wrench returns to an idle state thereof, the torque-breaking device and the abutting member automatically restore to abut against each other; the axis dividing the main body into a forward side and a rearward side, a centerline of the specially-shaped elastic member being inclined with respect to the axis by an angle of inclination, the fixing end of the specially-shaped elastic member being at the rearward side of the main body, the specially-shaped supporting segment of the specially-shaped elastic member crossing the axis of the main body and being located at the forward side of the main body; the torque-breaking device comprising a breaking member, the abutting member abutting against the breaking member; when the wrenching force applied by the digital-display torque wrench increases and becomes equal to the set torque value, the breaking member disengaging from the abutting member to break application of the wrenching force; when the digital-display torque wrench returns to the idle state, the breaking member and the abutting member automatically restoring to abut against each other; the terminal having a lateral formed with a first restricting portion, and the abutting member having a second restricting portion locationally corresponding to the first restricting portion, so that the first restricting portion and the second restricting portion abut against each other to define a swinging range of the abutting member; a restoring member being arranged between the terminal and the abutting member, the restoring member normally making the abutting member and the torque-breaking device abut against each other, an elastic member being arranged between the wrenching member and the main body to provide a force that returns the wrenching member to the idle state; the adjusting device being arranged between the terminal and the abutting member, the adjusting device comprising an adjusting member and a nut that is screwed into one end of the adjusting member, the adjusting member having an opposite end that is screwed into the terminal and abuts against the abutting member, the abutting member having a first abutting portion, the breaking member having a second abutting portion that is located at a lateral different from the specially-shaped elastic member and configured to abut against the first abutting portion, the adjusting member serving to adjust the swinging range of the abutting member with respect to the terminal, thereby changing a contacting area between the first abutting portion and the second abutting portion that abut against each other.

9. The digital-display torque wrench of claim 3, wherein the main body has a top side and a bottom side opposite to the top side along the operational axis, and the axial shaft is exposed outside the main body at the bottom side for the operating lever to be pivotally connected thereto, the first force-transferring member having a first connecting end and a first pressing portion, the second force-transferring member having a second connecting end and a second pressing portion located in the sliding member, and the second connecting end being slidably connected to the first connecting end, so that when the locking device is in the locking position, the first pressing portion presses on the main body, and the second pressing portion presses on the sliding member.

10. The digital-display torque wrench of claim 9, wherein the sliding member has a first toothed portion extending in a direction parallel to the axis, and the first force-transferring member has a second toothed portion that is located remote from the first pressing portion and formed around the operational axis, so that the second toothed portion engages with the first toothed portion, the first force-transferring member being rotatably installed along the operational axis on the axial shaft to be rotated to drive the sliding member to have the locational change with respect to the main body, the first force-transferring member having a rotating end that is remote from the first connecting end, the rotating end having a first radius of rotation, and the second toothed portion being formed along a second radius of rotation, wherein the first radius of rotation is greater than the second radius of rotation; the operating lever having an eccentric cam, when the locking device is in the locking position, the eccentric cam applying a force on the second force-transferring member to make the second force-transferring member and the first force-transferring member press toward each other, thereby holding the main body and the sliding member together tightly; the axial shaft of the locking device being provided with a threaded portion that passes through the first force-transferring member for a first screwing member and a second screwing member to be screwed therearound, and a disc spring being provided between the first screwing member and the first force-transferring member.

11. The digital-display torque wrench of claim 3, further comprising a biasing device, which is arranged between the main body and the sliding member, and applies a spring force to the sliding member along a direction perpendicular to the axis and the operational axis, wherein the biasing device comprises a leaf spring, whose two ends each have a hooking portion to hook a corresponding lateral of the sliding member.

12. The digital-display torque wrench of claim 4, wherein the axis divides the main body into a forward side and a rearward side, and the main body has an inner wall that includes a first inner wall at the rearward side and a second inner wall at the forward side, the wrenching device comprising a wrenching member, a link, and an acting member, the wrenching member being pivotally connected to the first end, the wrenching member having a terminal, the link being pivotally connected to the terminal, and the acting member being pivotally connected to the main body and configured to act between a first swinging position and a second swinging position with respect to the main body, so that the acting member and the link are interlocked; when the acting member is in the first swinging position, the acting member transmitting a counterforce of the wrenching device to the specially-shaped elastic member; when the torque-breaking device breaks transmission of the force applied by the digital-display torque wrench and makes the acting member swing to the second swinging position, the acting member driving the link to perform displacement with respect to the main body while making the wrenching member hit against the first inner wall, and the acting member hitting against the second inner wall; the wrenching member having a first impacting surface at one lateral of the terminal, a first impact space being defined between the first impacting surface and the first inner wall, the acting member having a second impacting surface at one lateral thereof, a second impact space being defined between the second impacting surface and the second inner wall; when the torque-breaking device breaks transmission of the force applied by the digital-display torque wrench, the first impacting surface entering the first impact space and hitting against the first inner wall, and the second impacting surface entering the second impact space and hitting against the second inner wall; when the digital-display torque wrench is in an idle state, a centerline of the link and the axis jointly including a first included angle, the second impacting surface and the axis jointly including an impact angle, and the link having a first connecting end and a second connecting end opposite to each other, the first connecting end being pivotally connected to the terminal, the second connecting end and the acting member being interlocked, the second connecting end of the link being located at the rearward side; when the torque-breaking device breaks transmission of the force applied by the digital-display torque wrench, the centerline of the link and the axis jointly including a second included angle, the first included angle being greater than the second included angle, the first included angle being greater than the impact angle, and the first connecting end of the link crossing the axis of the main body to be located at the rearward side of the main body together with the second connecting end; the torque-breaking device comprising a breaking member, the wrenching device having an abutting member that is pivotally connected thereto and is opposite to the wrenching end, the abutting member at one lateral contacting and being interlocked with the acting member, and at an opposite lateral abutting against and being connected to the breaking member; when a wrenching force applied by the digital-display torque wrench increases and becomes equal to the set torque value, the breaking member disengaging from the abutting member and thereby breaking transmission of the wrenching force applied by the digital-display torque wrench; when the digital-display torque wrench returns to the idle state, the breaking member and the abutting member automatically restoring to abut against each other; the adjusting device being arranged between the acting member and the abutting member, the adjusting device comprising an adjusting member and a nut screwed to one end of the adjusting member, the adjusting member having an opposite end that is screwedly connected to the abutting member and abuts against the acting member, the abutting member having a first abutting portion, the breaking member having a second abutting portion at a lateral thereof that is opposite to the specially-shaped elastic member to abut against the first abutting portion, the adjusting member being configured to adjust a swinging range of the abutting member with respect to the acting member and to thereby change a contacting area in which the first abutting portion abuts against the second abutting portion; a centerline of the specially-shaped elastic member being inclined with respect to the axis by an angle of inclination, the fixing end of the specially-shaped elastic member being located at the rearward side of the main body, the supporting segment of the specially-shaped elastic member crossing the axis of the main body to be located at the forward side of the main body, the torque-adjusting device when operated adjusting the axial location of the bearing portion with respect to the specially-shaped supporting segment, thereby changing the angle of inclination of the specially-shaped elastic member with respect to the main body; the specially-shaped elastic member being installed in the main body and inclined with respect to the axis of the main body, the specially-shaped supporting segment of the specially-shaped elastic member having a curved contacting area; the wrenching device further comprising two holding plates, the second connecting end of the link being pivotally connected to a lateral of each of the two holding plates, the abutting member being pivotally connected to an opposite lateral of each of the two holding plates, and the acting member being provided in duplicate to be stacked with and fixed to the two holding plates, the acting member having a first restricting portion that is remote from the wrenching end, the abutting member having a second restricting portion locationally corresponding to the first restricting portion, so that the first restricting portion and the second restricting portion abut against each other to define the swinging range of the abutting member; a restoring member being arranged between the acting member and the abutting member to normally make the abutting member and the breaking member abut against each other, and an elastic member being arranged between the wrenching member and the first inner wall of the main body to provide a force that returns the wrenching member to the idle state.

13. The digital-display torque wrench of claim 3, wherein the torque-sensing device comprising a sensing member and a display unit, the display unit being electrically connected to the sensing member, the sensing member having a movable portion, the movable portion being connected to and moving with the sliding member, so that the sensing member senses the locational change of the sliding member and generates a torque signal, the display unit displaying the set torque value according to the torque signal, the main body having an accommodating space, the main body having a sensing window that is between the first end and the second end and is communicated with the accommodating space, the sensing member sensing the locational change of the sliding member through the sensing window, the torque-sensing device further comprising a counter, the counter being configured to send a counting signal according to a number of times of disengagement between the breaking member and the abutting member and display the counting signal at the display unit, the wrenching device having a driving head and a wrenching member, the wrenching member being pivotally connected to the first end, the wrenching end being located at the driving head, the driving head being detachably installed on the wrenching member; and the main body further comprising a handle at the second end.
